(19) United States
(12) Patent Application Publication
(10) Pub. No.: US 2008/0181719 A1
(43) Pub. Date: Jul. 31, 2008

(54) ROTATING JOINT

(75) Inventors: John Gleason, South Lyon, MI (US); Reinhard Buhl, Bohmte (DE); William Ryan, Farmington Hills, MI (US)

Correspondence Address: GIFFORD, KRASS, SPRINKLE,ANDERSON & CITKOWSKI, P.C, PO BOX 7021, TROY, MI, 48007-7021, US

(73) Assignee: Z F Group North American Operations, Inc., Northville, MI (US)

(21) Appl. No.: 11/829,522

(22) Filed: Jul. 27, 2007

Related U.S. Application Data
(60) Provisional application No. 60/834,243, filed on Jul. 28, 2006.

(51) Int. Cl. F16C 11/06

(52) U.S. Cl. 403/76

(57) ABSTRACT

Disclosed is a component providing rotational, translational and angular movement to a shaft inserted therein. The component has a housing with a bearing aperture, the bearing aperture having an aperture axis, an inner concave surface and a placement ring surface. A combination joint including a hollow bearing and a placement ring are located at least partially within the bearing aperture. The hollow bearing has an outer convex surface adjacent to and at least partially in contact with the inner concave surface of the bearing aperture. The hollow bearing also has an aperture with a cylindrical inner surface. The placement ring has an outer surface adjacent to and at least partially in contact with the placement ring surface of the bearing aperture and has an inner concave bearing race surface adjacent to and at least partially in contact with the outer convex surface of the hollow bearing aperture. A sleeve with a sleeve axis can be located within the aperture of the hollow bearing and has an outer surface adjacent to and at least partially in contact with the cylindrical inner surface of the hollow bearing. The sleeve is slidable within the hollow bearing and the hollow bearing with the sleeve therein can rotate about the sleeve axis and tilt about the bearing aperture axis. In this manner, a component is provided that affords rotational, translational and angular movement to a shaft inserted therein. A seal can be included to protect the combination joint from dust, dirt, debris and the like.

### CROSS-REFERENCE TO RELATED APPLICATIONS

This application claims priority of U.S. Provisional Patent Application Ser. No. 60/834,243 filed Jul. 28, 2006, entitled “Rotating Joint”, which is incorporated herein by reference.

### FIELD OF THE INVENTION

The present invention concerns a rotating joint that may be integrated into a suspension link or yoke for a vehicle. More particularly, the invention concerns a compact, low friction, rotating joint that may be integrated into a wheel carrier member and that may bear high radial loads while also allowing for an angular misalignment and/or axial travel of a joint sleeve.

### BACKGROUND OF THE INVENTION

Rotating joints that are commonly associated with the suspension link or yoke of a vehicle are by nature often subjected to significant radial loads. As a result, prior art rotating joints have been specifically constructed to address these radial loads. However, where additional aggravating factors such as an angular misalignment of the link or yoke are also present, the additional strain on the rotating joint may result in the breakdown and premature failure of the joint. Therefore, it would be advantageous to have a rotating joint assembly capable of dealing with issues of joint misalignment and the like.

### SUMMARY OF THE INVENTION

Disclosed is a component providing rotational, translational and angular movement to a shaft inserted therein. The component has a housing with a bearing aperture, the bearing aperture having an aperture axis, an inner concave surface and a placement ring surface. A combination joint including a hollow bearing and a placement ring are located at least partially within the bearing aperture. The hollow bearing has an outer convex surface adjacent to and at least partially in contact with the inner concave surface of the bearing aperture. The hollow bearing also has an aperture with a cylindrical inner surface. The placement ring has an outer surface adjacent to and at least partially in contact with the placement ring surface of the bearing aperture and has an inner concave bearing race surface adjacent to and at least partially in contact with the outer convex surface of the hollow bearing aperture. A sleeve with a sleeve axis can be located within the aperture of the hollow bearing and has an outer surface adjacent to and at least partially in contact with the cylindrical inner surface of the hollow bearing. The sleeve is slidable within the hollow bearing and the hollow bearing with the sleeve therein can rotate about the sleeve axis and tilt about the bearing aperture axis. In this manner, a component is provided that affords rotational, translational and angular movement to a shaft inserted therein. A seal can be included to protect the combination joint from dust, dirt, debris and the like.

### BRIEF DESCRIPTION OF THE DRAWINGS

FIG. 1 is an exploded perspective view of an embodiment of the present invention;

FIG. 2 is a side cross-sectional view of an embodiment of the present invention; and

FIG. 3 is a side cross-sectional view of an embodiment of the present invention.

### DETAILED DESCRIPTION OF THE PREFERRED EMBODIMENTS

The present invention includes a component that affords rotational, translational and angular movement to a shaft inserted therein. As such, the present invention has utility as a component as well as a combination joint. The component of the present invention is an assembly including a housing, a hollow bearing, a placement ring and a sleeve. The housing has a bearing aperture with an aperture axis into which a combination joint including the hollow bearing, placement ring and sleeve can be inserted at least partially within. The hollow bearing has an outer convex surface that generally matches an inner concave surface of the bearing aperture. The hollow bearing also has an aperture with a cylindrical inner surface that affords for the sleeve to fit within. The placement ring has an outer surface adjacent to and at least partially in contact with a placement ring surface of the bearing aperture and an inner concave bearing race surface that generally matches the outer convex surface of the hollow bearing. The sleeve, having a sleeve axis, is slidable within the hollow bearing, the combination joint thereby affording translational movement of the sleeve along the sleeve axis. The outer convex surface of the hollow bearing and the inner convex surfaces of the bearing aperture and the placement ring afford the hollow bearing and the sleeve therein to rotate about the sleeve axis and tilt relative to the bearing aperture axis.

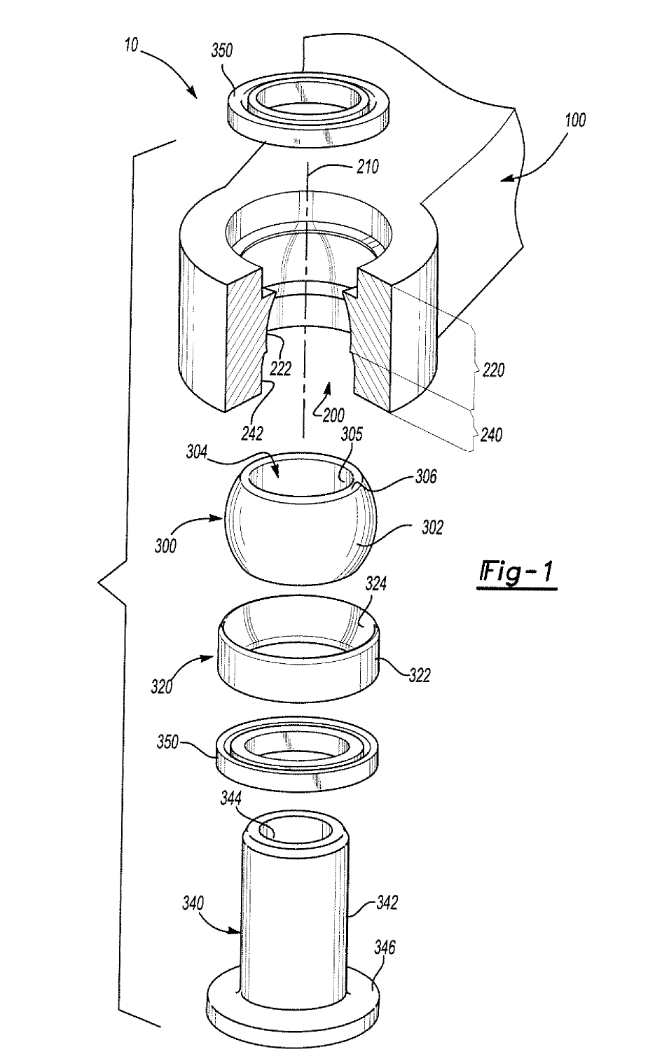

Referring now to FIG. 1, an exploded view of embodiment of the present invention is shown generally at 10. A housing 100 having a bearing aperture 200 can include an aperture axis 210, the bearing aperture 200 in some instances being cylindrical in shape and having a first section 220 and a second section 240. The first section 220 has an inner concave surface 222 which can be spheroidal in shape. The second section 240 has an internal surface in the form of a placement ring surface 242 which can be generally parallel to the aperture axis 210. In the alternative, the placement ring surface 242 is not generally parallel to the aperture axis 210.

The housing 100 can be a structural suspension link or yoke, or part thereof, for a motor vehicle. In addition, the housing 100 may be constructed of steel, metal alloys, thermoplastics or other synthetic composite materials. The inner concave surface 222 and placement ring surface 242 of the bearing aperture 200 can be formed by casting, machining and the like. Optionally, the surfaces 222 can be coated.

Inserted at least partially within the bearing aperture 200 is a hollow bearing 300. The hollow bearing 300 has an outer convex surface 302 and an aperture 304. The aperture 304 has an internal surface 305 which can be cylindrical in shape. The hollow bearing 300 can be truncated such that a flat end surface 306 is present. In some instances, the outer convex surface 302 is spheroidal in shape and can include indentations in the form of channels, dimples and the like wherein lubricant can be located. The outer convex surface 302 generally matches the inner concave surface 222 such that the surface 302 is adjacent to and at least partially in contact with the surface 222. In addition, the term “generally matches” is defined herein to mean a fit or tolerance between two adjacent surfaces such that general engineering standards within the automotive industry are met for the component and/or application being disclosed. The hollow bearing 300 may be constructed of steel, metal alloys or a thermoplastic material. For example, the hollow bearing 300 may be constructed of a polyamide, a polyoxymethylene, a polyether ether ketone, a polyphenylene sulfide, or a similar thermoplastic material.

Also inserted at least partially within the bearing aperture 200 is a placement ring 320, the ring 320 having an outer surface 322 and an inner concave surface 324. The placement ring 320 can secure the placement and/or location of the hollow bearing 200. The outer surface 322 can be cylindrically shaped and generally matches the placement ring surface 242 of the bearing aperture 200. The inner concave surface 324 generally matches the outer convex surface 302 of the hollow bearing 300. In some instances, the inner concave surface 324 can be spheroidal in shape. It is appreciated that the inner concave surfaces 222 and 324 can afford bearing race surfaces for hollow bearing 300.

Placement of the hollow bearing 300 within the bearing aperture 200 affords for the outer convex surface 302 to be adjacent to and at least partially in contact with the inner concave surface 222 of the bearing aperture 200. Insertion of the placement ring 320 within the bearing aperture 200 affords for the inner concave surface 324 to be adjacent to and at least partially in contact with the outer convex surface 302. In this manner, movement of the hollow bearing 300 is afforded within the bearing aperture 200 by sliding of the outer convex surface 302 against the inner concave surfaces 222 and 324.

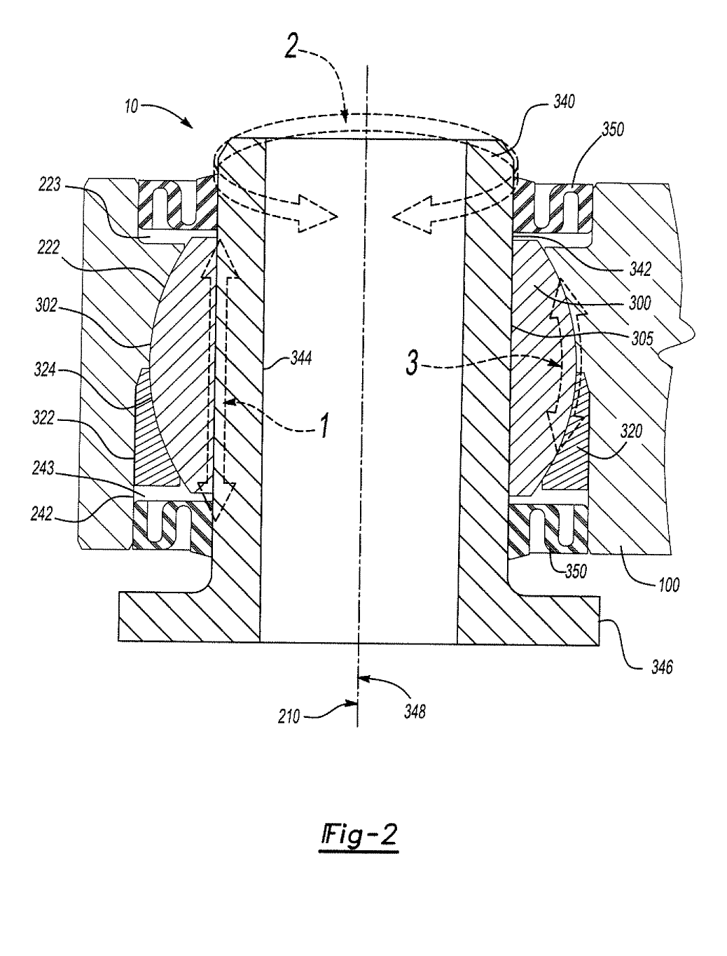

A sleeve 340 can be included and can fit within the aperture 304 of hollow bearing 300. An outer surface 342 of sleeve 340 generally matches the inner surface 305 of the aperture 304. The inner surface 344 of the sleeve 340 affords for a shaft (not shown) to be inserted therein. The tolerance between the outer surface 342 of the sleeve 340 and the inner surface 305 of aperture 304 affords for axial translation of the sleeve 340 within the bearing 300 as illustrated by arrow 1 shown in FIG. 2. In some instances, the sleeve 340 can slide within the hollow bearing 300 up to 8 millimeters. In other instances, the sleeve 340 can slide within the hollow bearing greater than 8 millimeters. The sleeve 340 can optionally include a flange 346 such that the sleeve is not allowed to slide all the way through the hollow bearing 300. It is appreciated that the sleeve 340 is not required for the present invention in that a shaft can be directly inserted within the aperture 304 of hollow bearing 300.

Optionally included are seals 350 which afford for the operation of the combination seal within the housing 100 free of debris, dirt, dust and the like. In addition, the seals 350 afford for lubricant that can be included within the combination joint to not leak out therefrom. The seals 350 can be made from any material known to those skilled in the art, illustratively including elastomers and plastics.

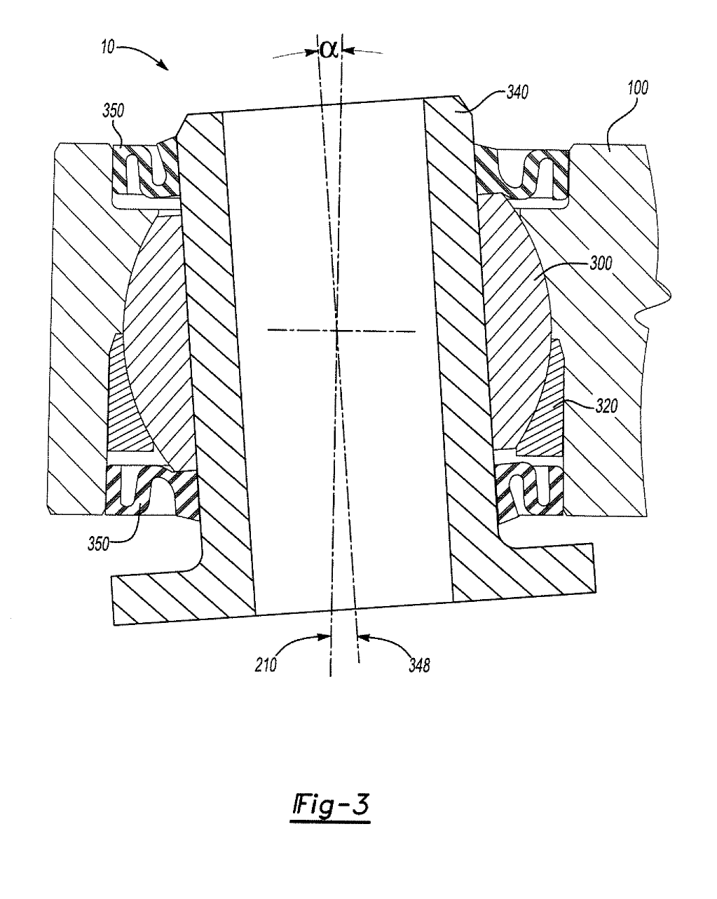

Turning now to FIGS. 2 and 3, side cross-sectional views are shown of the embodiment shown in FIG. 1 wherein the outer surface 342 of the sleeve 340 is adjacent to and at least partially in contact with the cylindrical aperture surface 305 of the hollow bearing 300. In addition, the inner concave surface 222 of the bearing aperture 200 and the inner concave surface 324 of the placement ring 320 are adjacent to and at least partially in contact with the outer convex surface 302 of the hollow bearing 300. Also shown is the placement of the seals 350 within the bearing aperture 200. Between the seals 350 and the hollow bearing 300 can be a first cavity region 223 and a second cavity region 243. Within these cavity regions, lubricant can be present. Although not shown in the figures, indentations in the form of channels, dimples and the like can be present at least partially within the surfaces 302, 304, 324 and 342, thereby affording for lubrication to be present and assist smooth movement between embodiment components 100, 300, 320 and 340.

Looking specifically at FIG. 2, a sleeve axis 348 in alignment with the aperture axis 210 is shown. It is appreciated that the sleeve 340 and the hollow bearing 300 can rotate as illustrated by arrow 2 about the sleeve axis 348, which may or may not be in alignment with aperture axis 210. In fact, the exact location of the placement ring 320 affords for an adjustable tension and/or force upon the hollow bearing 300 such that rotation of the sleeve 340 about the sleeve axis 348 can be dependent, or optionally independent, of rotation of the hollow bearing 300. The sleeve 340 and/or hollow bearing 300 can rotate 360 degrees about the aperture axis 210. It is appreciated that a shaft located within sleeve 340 can also rotate about the sleeve axis 348.

Turning to FIG. 3, the side cross-sectional view shown in this figure illustrates the ability of the combination joint to tilt about the aperture axis 210. As illustrated in this figure, the hollow bearing 300 with the sleeve 340 inserted therein can tilt at an angle defined as a relative to the aperture axis 210 per movement as illustrated by arrow 3 in FIG. 2. It is appreciated that a shaft located within sleeve 340 can also tilt relative to the aperture axis 210. In this manner, the present invention affords for the compensation of angular misalignment between a shaft inserted within the sleeve 340 and the component shown generally at 10. The sleeve may be made from steel, metal alloys or thermoplastic materials. In this manner, a component which affords axial, rotational and tilt movement is provided.

The foregoing drawings, discussion and description are illustrative of specific embodiments of the present invention, but they are not meant to be limitations upon the practice thereof. Numerous modifications and variations of the invention will be readily apparent to those of skill in the art in view of the teaching presented herein. It is the following claims, including all equivalents, which define the scope of the invention.

Having thus described my invention, I claim:

1. A component providing rotational, translational and angular movement to a shaft inserted therein, said component comprising:
a housing having a bearing aperture, said bearing aperture having an aperture axis, a concave bearing race surface and a placement ring surface;
a hollow bearing with an outer convex surface adjacent to and at least partially in contact with said concave bearing race surface of said bearing aperture, said hollow bearing also having an aperture with a cylindrical inner surface;
a placement ring having an outer surface adjacent to and at least partially in contact with said placement ring surface of said bearing aperture and a concave bearing race surface adjacent to and at least partially in contact with said outer convex surface of said hollow bearing;
a sleeve having a sleeve axis and an outer surface adjacent to and at least partially in contact with said sleeve race surface of said hollow bearing, said sleeve slidable within said hollow bearing, and said hollow bearing with said sleeve therein operable to rotate about said sleeve axis and tilt about said bearing aperture axis, for the purpose of providing rotational, translational and angular movement to a shaft inserted within said sleeve.

2. The invention of claim 1, wherein said sleeve can slide up to 8 millimeters within said hollow bearing.

3. The invention of claim 1, wherein said sleeve rotates about said sleeve axis independently of said hollow bearing.

4. The invention of claim 1, wherein said sleeve and said hollow bearing tilt up to 6 degrees about said aperture axis.

5. The invention of claim 1, wherein said housing is made from an alloy.

6. The invention of claim 5, wherein said alloy is a steel alloy.

7. The invention of claim 1, wherein said hollow bearing is made from a plastic.

8. The invention of claim 7, wherein said plastic is a high strength plastic.

9. The invention of claim 1, wherein said placement ring is made from an alloy.

10. The invention of claim 9, wherein said alloy is a steel alloy.

11. The invention of claim 1, wherein said inner surface and outer surface of said hollow bearing have indentations, said indentations selected from the group consisting of channels, dimples and combinations thereof.

12. A component providing rotational, translational and angular movement to a shaft inserted therein, said component comprising.
a housing having a bearing aperture with an aperture axis, said bearing aperture having a first section and a second section, said first section having a concave spheroidal bearing race surface and said second section having a cylindrical placement ring surface;
a hollow spheroidal bearing having an outer convex spheroidal surface adjacent to and at least partially in contact with said concave spheroidal bearing race surface of said first section of said bearing aperture, said hollow spheroidal bearing also having a cylindrical inner aperture, said cylindrical inner aperture having a sleeve bearing race surface;
a placement ring located within said second section having an outer cylindrical surface adjacent to and at least partially in contact with said cylindrical placement ring surface of said bearing aperture, said placement ring also having an inner spheroidal concave bearing race surface adjacent to and at least partially in contact with said outer spheroidal convex surface of said hollow bearing; and
a sleeve having a sleeve axis and extending through said cylindrical inner aperture of said hollow spheroidal bearing and having an outer sleeve surface adjacent to and at least partially in contact with said sleeve bearing race surface of said hollow spheroidal bearing, said sleeve slidable within said hollow spheroidal bearing along said sleeve axis;
said hollow spheroidal bearing with said sleeve therein operable to rotatable about said sleeve axis and tilt about said bearing aperture axis, for the purpose of providing rotational, translational and angular movement to a shaft inserted within said sleeve bearing.

13. The invention of claim 12, wherein said sleeve can slide up to 8 millimeters within said hollow bearing.

14. The invention of claim 12, wherein said sleeve and said hollow bearing tilt up to 6 degrees about said aperture axis.

15. The invention of claim 12, wherein said sleeve rotates about said sleeve axis independently of said hollow bearing.

16. The invention of claim 12, wherein said housing is made from an alloy.

17. The invention of claim 16, wherein said alloy is a steel alloy.

18. The invention of claim 12, wherein said hollow bearing is made from a plastic.

19. The invention of claim 18, wherein said plastic is a high strength plastic.

20. The invention of claim 12, wherein said inner surface and outer surface of said hollow bearing have indentations, said indentations selected from the group consisting of channels, dimples and combinations thereof.
